(19) United States
(12) Patent Application Publication
(10) Pub. No.: US 2026/0132911 A1
(43) Pub. Date: May 14, 2026

(54) LIGHTING APPARATUS

(71) Applicant: LEEDARSON LIGHTING CO.,LTD., Zhangzhou (CN)

(72) Inventors: Chenliang Liang, Zhangzhou (CN); Jinhua XIEH, Zhangzhou (CN); Haiyan CHEN, Zhangzhou (CN); Zhenhong ZHU, Zhangzhou (CN); Yan LIU, Zhangzhou (CN)

(21) Appl. No.: 19/386,910

(22) Filed: Nov. 12, 2025

(30) Foreign Application Priority Data
Nov. 13, 2024 (CN) 202422769548.4
Nov. 13, 2024 (CN) 202422769568.1
Nov. 13, 2024 (CN) 202422770520.2
Nov. 13, 2024 (CN) 202422770644.0

(51) Int. Cl. F21V 17/06; F21V 3/00; F21V 31/00; F21Y 115/10

(52) U.S. Cl. CPC F21V 17/06; F21V 3/00; F21V 31/005; F21Y 2115/10

(57) ABSTRACT

A lighting apparatus includes a lamp body, a lamp cover, and a hinge structure formed as an extruded polymer member that connects the lamp body to the lamp cover. The hinge structure has a first fixing portion, a second fixing portion, and a connecting section. The first fixing portion is secured to the lamp body, and the second fixing portion is secured to one side of the lamp cover. The lamp cover rotates relative to the lamp body along the hinge structure. When the lamp body is installed on a ceiling or wall, the lamp cover hangs downward for user access during setup and is then rotated upward to close and seal with the lamp body.

### FIELD

The present invention is related to a lighting apparatus, and more particularly related to a lighting apparatus with a convenient installation structure.

### BACKGROUND

The field of lighting technology has experienced rapid development over the past several decades. In particular, the rise of light-emitting diode (LED) technology has fundamentally reshaped how illumination devices are designed and deployed in residential, commercial, and industrial environments. LEDs have steadily displaced traditional incandescent and fluorescent light sources due to their energy efficiency, longevity, and adaptability.

One of the primary drivers behind the fast adoption of LEDs is their ability to convert electrical energy into light with far greater efficiency than incandescent filaments or gas-discharge tubes. This efficiency translates directly into lower power consumption and reduced operating costs, which are key considerations for both consumers and large-scale facility operators.

Another reason LEDs have proliferated is their significantly extended operational life compared with traditional lamps. While incandescent bulbs may last for around one thousand hours, LED devices can often achieve tens of thousands of hours of service, thereby reducing replacement frequency and maintenance demands. This durability has made LEDs highly attractive in applications where accessibility is limited or replacement is costly.

The compact size of LED chips has also fueled design innovation in lighting products. Unlike bulky fluorescent tubes or fragile glass bulbs, LEDs can be integrated into small enclosures, flexible strips, or unconventional form factors. This allows designers to create lighting devices that are not only functional but also aesthetically pleasing and adaptable to architectural or decorative needs.

The ability of LEDs to produce light across a wide spectrum of colors without filters has further expanded their application space. By combining different semiconductor materials or using phosphor coatings, LEDs can generate warm white, cool white, or even tunable color temperatures, enabling more precise control over ambience and visual comfort.

Alongside these technical benefits, LEDs have been incorporated into lighting systems with increasing levels of control sophistication. Early implementations often relied on simple on-off switching, but modern systems may include dimming, color adjustment, and integration with digital or wireless controllers. As lighting has become smarter, the importance of effective user control has become equally significant.

Traditional methods of light control remain widespread. The most common is the wall switch, typically installed on a building's wiring system and used to manually connect or disconnect power to the lighting circuit. This approach is familiar, reliable, and inexpensive, but it lacks flexibility once installed, as the switch position is fixed and its wiring predetermined.

Some lighting devices integrate manual switches directly into the lamp body or base. These switches may be toggles, push buttons, or rotary knobs that allow a user to operate the light without reliance on a wall-mounted fixture. Such switches provide convenience in portable lamps or task lights, but they can be less convenient when the device is installed in an overhead location or otherwise difficult to reach.

Other systems incorporate remote control technologies, whether infrared, radio frequency, or network-based, to allow operation from a distance. While these systems provide significant convenience, they introduce added complexity, require additional components, and may be prone to interference or failure if the controlling device is misplaced or its power source is depleted.

Touch-sensitive controls have also emerged, particularly in desk lamps or decorative fixtures. By responding to skin contact rather than mechanical actuation, such controls offer sleek appearance and minimal moving parts. However, they can be overly sensitive, leading to accidental activation, and may not function reliably in all environmental conditions.

Smart lighting solutions extend control even further by integrating with mobile applications, home automation hubs, or voice assistants. These systems allow scheduling, grouping, and dynamic adjustment of lighting characteristics. While technologically advanced, they depend on network connectivity and software maintenance, which may be intimidating for some users or introduce vulnerabilities.

Each of these control methods therefore carries distinct advantages and disadvantages. Wall switches are robust but inflexible, integrated switches are convenient but sometimes inconveniently located, remote controls add flexibility but also reliance on external devices, and smart systems offer versatility at the expense of complexity.

In addition, the diversity of LED lamp designs, including compact bulbs, strip lights, and embedded fixtures, means that not all control methods can be applied uniformly. For example, the limited space available in a compact LED bulb may not accommodate traditional switches, while large fixtures may not justify sophisticated network control.

Consequently, there exists a need for more adaptable, user-friendly methods of controlling lighting devices. Such methods should accommodate the compact size and unique requirements of modern LED bulbs and fixtures, while balancing convenience, cost, and reliability.

When a lighting device is installed on a ceiling, users often need to lift the unit overhead while simultaneously connecting electrical wires and securing mounting components. This process requires the installer to work at an elevated position, frequently on a ladder or platform, which inherently increases the risk of accidents such as falling or dropping the fixture. Because lighting devices typically include metallic housings, drivers, and fragile optical components, any loss of grip or instability during installation can result in personal injury or product damage.

The difficulty is further compounded by the weight and shape of the lighting apparatus. Many ceiling-mounted luminaires are bulky or elongated, making them difficult for a single person to handle. The need to align screw holes, manage power cables, and maintain the correct orientation of the lamp while keeping balance creates a physically demanding and unsafe working condition. Improper handling may also cause electrical hazards if wires are inadvertently pulled or exposed.

Therefore, a well-designed structural arrangement is essential to facilitate safe and convenient installation. A hinge or coupling mechanism that allows the lamp body and the lamp cover to be separated or partially opened during setup enables users to perform wiring and configuration tasks with minimal effort. Such structures allow the lamp to be temporarily supported while adjustments are made, reducing the risk of the device slipping or falling.

Additionally, a mechanical support or locking design that ensures the lighting unit can be pre-hung or partially engaged before final fastening greatly improves safety. When installers can securely position the lamp body on the ceiling before making electrical connections, the likelihood of accidental dropping is minimized. This design not only enhances user safety but also shortens installation time and improves overall reliability.

In conclusion, ceiling-mounted lighting installation inherently involves potential hazards due to elevation, weight, and electrical factors. Providing a structural design that supports the lamp during installation—such as a hinge structure, coupling mechanism, or safety locking feature—protects users from injury, ensures proper alignment, and prevents damage to the lighting apparatus. Such improvements represent significant advancements in both safety and user experience.

### SUMMARY

In some embodiments, a lighting apparatus includes a lamp body, a hinge structure and the lamp cover.

The hinge structure is an extruded polymer member connecting the lamp body and a lamp cover.

The hinge structure includes a first fixing portion, a second fixing portion, and a connecting section.

The first fixing portion is fixedly connected to the lamp body.

The second fixing portion is fixedly connected to a first cover side of the lamp cover.

The lamp cover is rotatable relative to the lamp body along the hinge structure. When the lamp body is mounted at an installation position, the lamp cover hangs downward for user access to perform configuration and installation of the lamp body, and after installation is completed, the lamp cover is rotated along the hinge structure to engage and close with the lamp body.

In some embodiments, the lamp cover further includes a coupling structure disposed at a second cover side of the lamp cover,

In some embodiments, the coupling structure includes an elastic member and a movable member.

A user operates the movable member to engage the lamp cover with the lamp body and releases the movable member to complete fixation.

In some embodiments, the coupling structure includes an elastic member and a slanted latch member. A user operates the movable member to engage the lamp cover with the lamp body and releases the movable member to complete fixation.

In some embodiments, the lamp body includes a locking hole.

The coupling structure includes a locking hook configured to engage the locking hole for fixation.

In some embodiments, the second cover side of the lamp cover includes a waterproof strip configured to prevent moisture ingress into the lamp body when the lamp cover and the lamp body are fixed together.

In some embodiments, the lamp body includes a driver and a configuration switch, wherein, when the lamp cover is opened, a user operates the configuration switch to perform parameter setting of a driving circuit.

In some embodiments, the lighting apparatus may also include a light source including a plurality of LED modules having different optical parameters.

The configuration switch is operable to adjust a mixing ratio of the LED modules to obtain a desired color temperature.

In some embodiments, the configuration switch includes indicia corresponding to a plurality of discrete color-temperature settings.

In some embodiments, the hinge structure further includes a conductive channel.

The lamp cover includes a light source electrically connected to a power supply of the lamp body through the conductive channel.

In some embodiments, the first fixing portion includes a plurality of first fasteners, and the second fixing portion includes a plurality of second fasteners. The plurality of first fasteners and the plurality of second fasteners are alternately arranged.

In some embodiments, the second fixing portion of the hinge structure and the lamp cover are fixed through a sliding-rail structure.

In some embodiments, the lamp body includes a housing defining an accommodation space in which a driver box is disposed.

The housing includes a wire-passing hole through which an external power cable extends to the driver box.

In some embodiments, the lamp body includes an LED module having a protective layer.

In some embodiments, the extruded polymer member has different wall thicknesses along different segments thereof.

In some embodiments, the lamp body includes a strip-shaped light source.

In some embodiments, the lamp cover includes a lens structure corresponding to the strip-shaped light source.

In some embodiments, the hinge structure further includes a metal strip embedded therein, wherein, when the extruded polymer member melts under fire conditions, the metal strip maintains mechanical connection between the lamp body and the lamp cover.

In some embodiments, the hinge structure is light-transmissive and includes a light source configured to emit light through the hinge structure to generate a side-light effect.

In some embodiments, the lamp body includes a driver operable to selectively activate the side-light effect.

### BRIEF DESCRIPTION OF DRAWINGS

FIG. 1 is a structural schematic diagram of a linear lighting apparatus according to an embodiment of the present disclosure.

FIG. 2 is a structural schematic diagram of a locking assembly used in an embodiment of the present disclosure.

FIG. 3 is another structural schematic diagram of the locking assembly used in an embodiment of the present disclosure.

FIG. 4 is a partial schematic view of the provided linear lighting apparatus.

FIG. 5 is a side view of a hinge assembly used in an embodiment of the present disclosure.

FIG. 6 is a sectional view of the linear lighting apparatus according to an embodiment of the present disclosure.

FIG. 7 illustrates an embodiment of a lighting apparatus.

FIG. 8 shows a hinge structure example.

FIG. 9 shows another hinge structure example.

### DETAILED DESCRIPTION

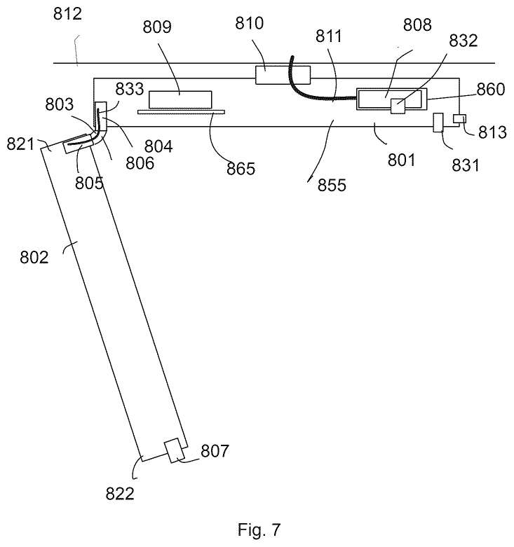

In FIG. 7, a lighting apparatus includes a lamp body 801, a hinge structure 803 and the lamp cover 802.

The hinge structure 803 is an extruded polymer member connecting the lamp body 801 and a lamp cover 802.

The hinge structure 803 includes a first fixing portion 804, a second fixing portion 805, and a connecting section 806.

The first fixing portion 804 is fixedly connected to the lamp body 801.

The second fixing portion 805 is fixedly connected to a first cover side 821 of the lamp cover 802.

The lamp cover 802 is rotatable relative to the lamp body 801 along the hinge structure 803. When the lamp body 801 is mounted at an installation position 812, the lamp cover 802 hangs downward for user access to perform configuration and installation of the lamp body 801, and after installation is completed, the lamp cover 802 is rotated along the hinge structure 803 to engage and close with the lamp body 801.

In some embodiments, the lamp cover further includes a coupling structure 807 disposed at a second cover side 822 of the lamp cover 802.

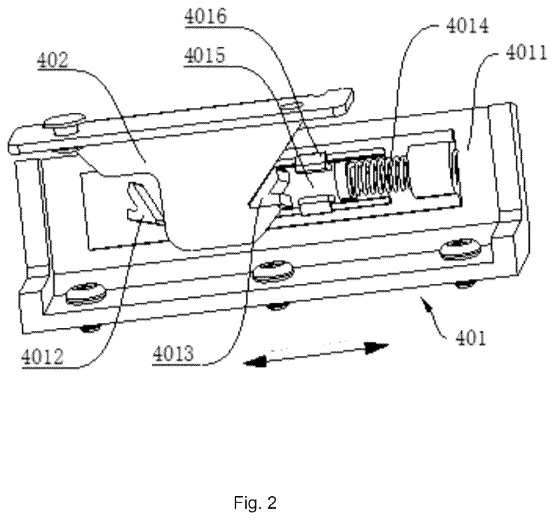

In some embodiments, the coupling structure 822 includes an elastic member and a movable member. A clear example is provided and explained together with FIG. 2.

A user operates the movable member to engage the lamp cover with the lamp body and releases the movable member to complete fixation.

In some embodiments, the coupling structure includes an elastic member and a slanted latch member. A user operates the movable member to engage the lamp cover with the lamp body and releases the movable member to complete fixation.

In some embodiments, the lamp body includes a locking hole.

The coupling structure includes a locking hook configured to engage the locking hole 813 for fixation.

In some embodiments, the second cover side of the lamp cover includes a waterproof strip 831 configured to prevent moisture ingress into the lamp body 801 when the lamp cover 802 and the lamp body 801 are fixed together.

In some embodiments, the lamp body 801 includes a driver 808 and a configuration switch 832. When the lamp cover is opened, a user operates the configuration switch 832 to perform parameter setting of a driver 808.

In some embodiments, the lighting apparatus may also include a light source 809 including a plurality of LED modules having different optical parameters.

The configuration switch 832 is operable to adjust a mixing ratio of the LED modules to obtain a desired color temperature.

In some embodiments, the configuration switch 832 includes indicia corresponding to a plurality of discrete color-temperature settings.

In some embodiments, the hinge structure further includes a conductive channel 833.

The lamp cover includes a light source 809 electrically connected to a power supply of the lamp body 801 through the conductive channel 833.

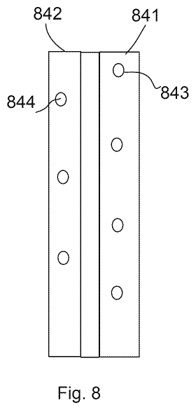

In FIG. 8, the first fixing portion 841 includes a plurality of first fasteners 843, and the second fixing portion 842 includes a plurality of second fasteners 844. The plurality of first fasteners 843 and the plurality of second fasteners 844 are alternately arranged.

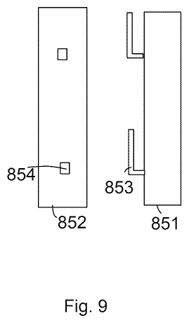

In FIG. 9, the second fixing portion of the hinge structure and the lamp cover are fixed through a sliding-rail structure 853, 854, by sliding the components to fix together.

In FIG. 7, the lamp body includes a housing defining an accommodation space 855 in which a driver box 860 is disposed.

The housing includes a wire-passing hole 810 through which an external power cable 811 extends to the driver box 860.

In some embodiments, the lamp body includes an LED module having a protective layer 865.

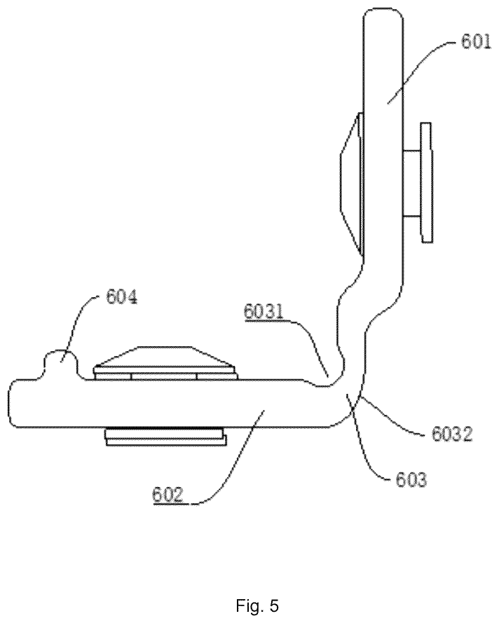

In some embodiments, the extruded polymer member has different wall thicknesses along different segments thereof, as illustrated in the example of FIG. 5

In some embodiments, the lamp body includes a strip-shaped light source.

In some embodiments, the lamp cover includes a lens structure corresponding to the strip-shaped light source.

In some embodiments, the hinge structure further includes a metal strip embedded therein, wherein, when the extruded polymer member melts under fire conditions, the metal strip maintains mechanical connection between the lamp body and the lamp cover.

In some embodiments, the hinge structure is light-transmissive and includes a light source configured to emit light through the hinge structure to generate a side-light effect. For example, the conductive channel 833 can be the place to embed such structure.

In some embodiments, the lamp body includes a driver operable to selectively activate the side-light effect.

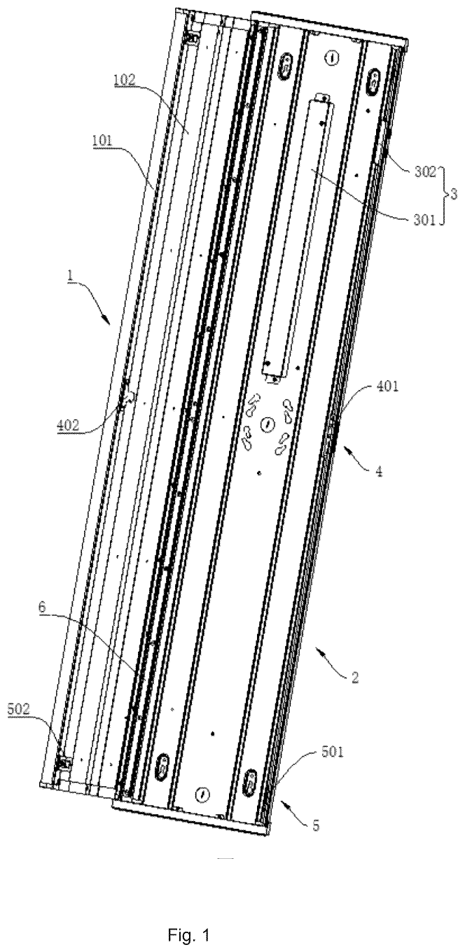

Referring to FIGS. 1-6, the present utility model provides a linear lighting apparatus. The apparatus includes a lamp body 2, a lamp cover 1, a light source unit 7, a driver assembly 3, and a locking assembly 4. The lamp body 2 defines an accommodation cavity 201 and a fixing region for securing to a mounting surface, and the accommodation cavity 201 has an open top. The lamp cover 1 is rotatably connected to the lamp body 2 and is configured to close the opening of the accommodation cavity 201. The lamp cover 1 includes a light-transmitting cover 101 and a heat-dissipating plate 102 connected to the light-transmitting cover 101. The light-transmitting cover 101 and the heat-dissipating plate 102 together define a sealed mounting chamber 103. The light source unit 7 is disposed within the mounting chamber 103 and fixed to the heat-dissipating plate 102. The driver assembly 3 is disposed in the accommodation cavity 201 and electrically connected to the light source unit 7. The locking assembly 4 is disposed in the accommodation cavity 201 and includes a coupling member 401 connected to the lamp body 2 and a hook 402 connected to the lamp cover 1. The coupling member 401 includes a base 4011 and a locking portion slidably connected to the base 4011 along a first path. The locking assembly 4 further includes a driving portion and an elastic member 4014, the elastic member 4014 providing a preload force that keeps the locking portion engaged with the hook 402. The driving portion extends outward from the accommodation cavity 201 and is configured to separate the locking portion from the hook 402.

The linear lighting apparatus provided by the present disclosure, compared with the prior art, positions the light source unit 7 inside the sealed mounting chamber 103 formed by the light-transmitting cover 101 and the heat-dissipating plate 102. Because the mounting chamber 103 is a closed space, it prevents moisture or dust from the external environment from contaminating the light source unit 7, and also avoids exposure of the light source unit 7 during installation, thereby preventing damage. The driver assembly 3 and the locking assembly 4 are arranged in the accommodation cavity 201, while the light source unit 7 is arranged in the mounting chamber 103, achieving an efficient spatial layout that avoids insufficient internal space. The lamp body 2 and the lamp cover 1 are rotatably connected and are engaged by the coupling member 401 and the hook 402. The locking assembly 4 has a simple structure that eliminates the need for complicated installation steps caused by separate designs, requires no external alignment or fasteners, and thus greatly simplifies installation and improves assembly efficiency.

It should be noted that the first path is parallel to the extending direction of the lamp body 2.

Optionally, the lamp body 2 and the lamp cover 1 may be rotatably connected through a hinge.

Optionally, the lamp body 2 may include a mounting hole, and the lamp body 2 may be fixed by inserting a fastener into the mounting hole.

In one embodiment of the coupling member, the coupling member 401 includes the base 4011 and first and second locking blocks 4012 and 4013 disposed along the first path on the base 4011. At least one of the first locking block 4012 and the second locking block 4013 is slidably connected to the base 4011, and the first locking block 4012 and/or the second locking block 4013 forms the locking portion.

Optionally, both the first locking block 4012 and the second locking block 4013 are slidably connected to the base 4011 along the first path, and each is connected to an elastic member 4014. One elastic member 4014 applies a force to the first locking block 4012, and another elastic member 4014 applies a force to the second locking block 4013, causing the first and second locking blocks to move toward each other, with both forming locking portions.

Optionally, the first locking block 4012 is fixed to the base 4011 and the second locking block 4013 is slidably connected to the base 4011, the elastic member 4014 being configured to apply a preload that drives the second locking block 4013 to slide toward the first locking block 4012, with the second locking block 4013 forming the locking portion. Alternatively, the second locking block 4013 is fixed to the base 4011 and the first locking block 4012 is slidably connected to the base 4011, the elastic member 4014 being configured to apply a preload that drives the first locking block 4012 to slide toward the second locking block 4013, with the first locking block 4012 forming the locking portion.

Optionally, when no external force is applied, the first locking block 4012 and the second locking block 4013 contact each other along the first path, or are spaced apart along the first path by a distance smaller than the dimension of the hook 402 in the same direction.

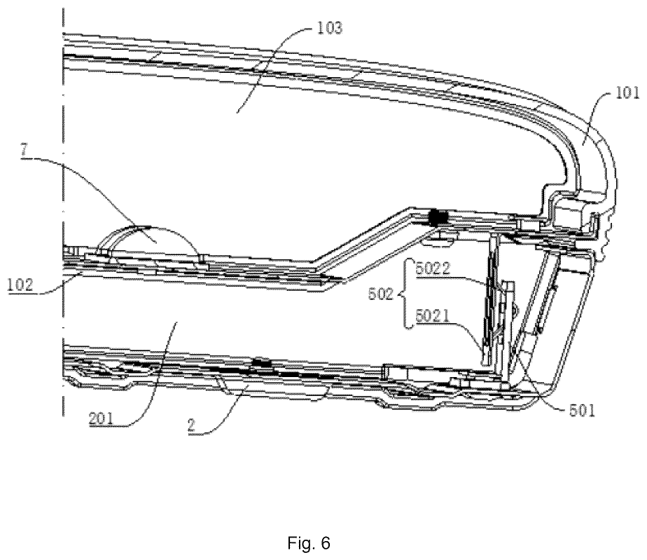

In some embodiments, referring to FIGS. 1 and 6, the linear lighting apparatus further includes a fixing assembly 5. The fixing assembly 5 includes a fixing frame 501 and an elastic latch 502. The fixing frame 501 is connected to the lamp cover 1 and defines a fixing hole. The elastic latch 502 is disposed within the accommodation cavity 201 and connected to the lamp body 2. The elastic latch 502 includes a latching portion configured to engage with the fixing hole.

When the lamp body 2 and the lamp cover 1 are closed, the latching portion of the elastic latch 502 engages the fixing hole. When the lamp body 2 and the lamp cover 1 are separated, the latching portion disengages from the fixing hole. The fixing assembly 5 cooperates with the locking assembly 4 to further enhance the firmness and reliability of the connection between the lamp body 2 and the lamp cover 1.

In some embodiments, referring to FIG. 6, the elastic latch 502 includes an elastic base 5021 and an elastic sheet 5022. The elastic base 5021 includes a mounting plate connected to the lamp body 2 and a latching plate angled relative to the mounting plate. The elastic sheet 5022 is attached to the latching plate and forms the latching portion. The elastic sheet 5022 includes two latching zones arranged at an angle, one connected to the latching plate, and the joint between the two latching zones is inserted into the fixing hole.

The joint between the two latching zones forms an angle, and when inserted into the fixing hole, it locks the lamp body 2 and the lamp cover 1 together. To open the lamp cover 1, an external force is applied to the lamp cover 1, causing elastic deformation of the latching zones, thereby releasing them from the fixing hole.

Optionally, one latching zone is connected to the latching plate, and the other is a free end, facilitating elastic deformation and allowing easy engagement and disengagement of the latching portion with the fixing hole.

In some embodiments, referring to FIG. 1, the driver assembly 3 includes a driver 301 and a dial switch 302. The driver 301 is disposed within the accommodation cavity 201 and fixed to the lamp body 2, and is electrically connected to the light source unit 7. The dial switch 302 is electrically connected to the driver 301 and fixed to the lamp body 2, with its switch extending outside the accommodation cavity 201.

Because the switch of the dial switch 302 extends outward from the accommodation cavity 201, users can control the driver 301 through the dial switch 302 to adjust parameters of the light source unit 7, such as color or color temperature. In this embodiment, both the dial switch 302 and the driver 301 are disposed in the accommodation cavity 201, ensuring a compact internal layout and convenient operation.

In some embodiments, referring to FIGS. 1-3, the linear lighting apparatus further includes a hinge assembly 6. The hinge assembly 6 includes a first mounting portion 601, a hinge portion 603, and a second mounting portion 602 connected in sequence. The hinge portion 603 is a flexible member capable of elastic deformation. The first mounting portion 601 and the second mounting portion 602 are rotatably connected by the hinge portion 603. The first mounting portion 601 has a closed position parallel or contacting the second mounting portion 602, and an open position forming an angle or lying in the same plane. The first and/or second mounting portions rotate about the hinge portion 603 to switch between the open and closed positions.

The first mounting portion 601 and the second mounting portion 602 are respectively connected to the lamp body 2 and the lamp cover 1. During installation, the first and second mounting portions are in the open position. Because they are connected via the hinge portion 603, the installer does not need to hold the lamp cover 1. After the lamp body 2 is fixed, the first mounting portion 601 is rotated about the hinge portion 603 to the closed position, securing the lamp cover 1 to the lamp body 2. Since the hinge portion 603 is a flexible member capable of elastic deformation, no metal shaft is required, simplifying structure and reducing weight. This configuration allows single-person installation without lifting the lamp cover 1, lowering labor costs. Moreover, since the first and second mounting portions attach respectively to the lamp body 2 and lamp cover 1, the design can be applied to different lamp models without modifying their main structures, reducing design and production costs.

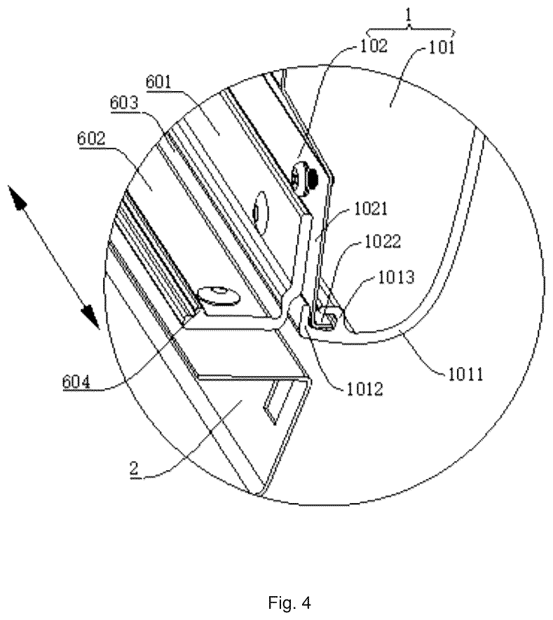

In some embodiments, referring to FIGS. 4-5, the inner side of the hinge portion 603 includes an arcuate groove 6031, and the outer side includes an arcuate projection 6032, giving the hinge portion 603 a curved cross section.

When the first mounting portion 601 and the second mounting portion 602 move from the open position to the closed position, the hinge portion 603 deforms, with the outer side undergoing a larger deformation than the inner side. If the hinge portion 603 were flat, the outer side would be overstretched while the inner side would buckle, causing gaps and possible fracture. In this embodiment, the arcuate projection 6032 on the outer side increases the deformation path to prevent rupture, and the arcuate groove 6031 on the inner side prevents material stacking when closed.

It should be noted that during bending of the hinge portion 603, the inner side travels a shorter distance than the outer side, meaning less deformation. The smaller inner surface area and larger outer surface area ensure sufficient flexibility on the outer side while preventing protrusion on the inner side.

In some embodiments, referring to FIGS. 4-5, the first and/or second mounting portions 601, 602 include a limiting rib 604. In the closed state, the limiting rib 604 forms a clearance space between the first and second mounting portions.

When closed, the limiting rib 604 abuts one of the mounting portions to prevent collision during rotation and to avoid interference of locking members, thereby improving connection reliability.

Optionally, the limiting rib 604 is made of a flexible material, such as rubber, plastic, or EVA, to prevent rigid contact. The limiting rib 604 may be integrally formed with or separately attached to either mounting portion.

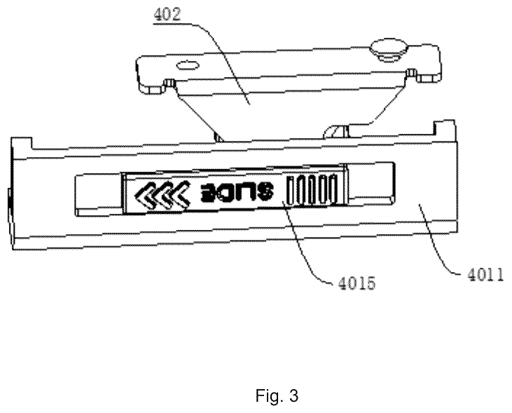

In some embodiments, referring to FIGS. 2-3, the base 4011 defines a clearance hole penetrating therethrough. The coupling device includes a cover plate 4015 covering the clearance hole and a driving block 4016 connected to the cover plate 4015. The driving block 4016 slides within the clearance hole to form the driving portion.

By moving the cover plate 4015 along the first path, the driving block 4016 slides within the clearance hole, compressing the elastic member 4014 and releasing the hook 402. The cover plate 4015 seals the clearance hole to enhance the internal sealing of the lamp body 2 and lamp cover 1, preventing moisture or dust ingress and extending service life.

Optionally, when both the first and second locking blocks 4012, 4013 are slidably connected to the base 4011, two elastic members 4014 apply force respectively, and two cover plates 4015 and corresponding driving blocks 4016 are provided. By moving the two cover plates 4015 in opposite directions, the first and second locking blocks 4012, 4013 move apart.

Optionally, the first or second locking block 4012, 4013 is connected to the cover plate 4015. Specifically, the lamp body 2 defines a relief hole communicating with the accommodation cavity 201, and the driving block 4016 slides within the relief hole.

In some embodiments, referring to FIG. 4, the light-transmitting cover 101 includes a cover body 1011, a fixing flange 1012 at the edge of the cover body 1011, and a latching strip 1013 connected to the cover body 1011. The fixing flange 1012 and the latching strip 1013 are spaced apart to form a mounting groove, into which the heat-dissipating plate 102 is inserted.

This plug-in connection between the heat-dissipating plate 102 and the light-transmitting cover 101 avoids the need for openings in either component, improving sealing within the mounting chamber 103 and preserving the integrity of the light-transmitting cover 101.

In some embodiments, referring to FIG. 4, the latching strip 1013 includes a connecting portion and a limiting portion arranged at an angle. The connecting portion connects to the cover body 1011, and the limiting portion bends toward the mounting groove. The heat-dissipating plate 102 includes a main plate 1021 and a latching flange 1022 extending from its edge. The latching flange 1022 is inserted into the mounting groove and engages the limiting portion.

By engaging the latching flange 1022 with the limiting portion, the components are secured without tight interference, reducing insertion resistance while ensuring stable fixation through mechanical engagement. Referring to FIGS. 1-6, the present utility model provides a linear lighting apparatus. The apparatus includes a lamp body 2, a lamp cover 1, a light source unit 7, a driver assembly 3, and a locking assembly 4. The lamp body 2 defines an accommodation cavity 201 and a fixing region for securing to a mounting surface, and the accommodation cavity 201 has an open top. The lamp cover 1 is rotatably connected to the lamp body 2 and is configured to close the opening of the accommodation cavity 201. The lamp cover 1 includes a light-transmitting cover 101 and a heat-dissipating plate 102 connected to the light-transmitting cover 101. The light-transmitting cover 101 and the heat-dissipating plate 102 together define a sealed mounting chamber 103. The light source unit 7 is disposed within the mounting chamber 103 and fixed to the heat-dissipating plate 102. The driver assembly 3 is disposed in the accommodation cavity 201 and electrically connected to the light source unit 7. The locking assembly 4 is disposed in the accommodation cavity 201 and includes a coupling member 401 connected to the lamp body 2 and a hook 402 connected to the lamp cover 1. The coupling member 401 includes a base 4011 and a locking portion slidably connected to the base 4011 along a first path. The locking assembly 4 further includes a driving portion and an elastic member 4014, the elastic member 4014 providing a preload force that keeps the locking portion engaged with the hook 402. The driving portion extends outward from the accommodation cavity 201 and is configured to separate the locking portion from the hook 402.

The linear lighting apparatus provided by the present disclosure, compared with the prior art, positions the light source unit 7 inside the sealed mounting chamber 103 formed by the light-transmitting cover 101 and the heat-dissipating plate 102. Because the mounting chamber 103 is a closed space, it prevents moisture or dust from the external environment from contaminating the light source unit 7, and also avoids exposure of the light source unit 7 during installation, thereby preventing damage. The driver assembly 3 and the locking assembly 4 are arranged in the accommodation cavity 201, while the light source unit 7 is arranged in the mounting chamber 103, achieving an efficient spatial layout that avoids insufficient internal space. The lamp body 2 and the lamp cover 1 are rotatably connected and are engaged by the coupling member 401 and the hook 402. The locking assembly 4 has a simple structure that eliminates the need for complicated installation steps caused by separate designs, requires no external alignment or fasteners, and thus greatly simplifies installation and improves assembly efficiency.

It should be noted that the first path is parallel to the extending direction of the lamp body 2.

Optionally, the lamp body 2 and the lamp cover 1 may be rotatably connected through a hinge.

Optionally, the lamp body 2 may include a mounting hole, and the lamp body 2 may be fixed by inserting a fastener into the mounting hole.

In one embodiment of the coupling member, the coupling member 401 includes the base 4011 and first and second locking blocks 4012 and 4013 disposed along the first path on the base 4011. At least one of the first locking block 4012 and the second locking block 4013 is slidably connected to the base 4011, and the first locking block 4012 and/or the second locking block 4013 forms the locking portion.

Optionally, both the first locking block 4012 and the second locking block 4013 are slidably connected to the base 4011 along the first path, and each is connected to an elastic member 4014. One elastic member 4014 applies a force to the first locking block 4012, and another elastic member 4014 applies a force to the second locking block 4013, causing the first and second locking blocks to move toward each other, with both forming locking portions.

Optionally, the first locking block 4012 is fixed to the base 4011 and the second locking block 4013 is slidably connected to the base 4011, the elastic member 4014 being configured to apply a preload that drives the second locking block 4013 to slide toward the first locking block 4012, with the second locking block 4013 forming the locking portion. Alternatively, the second locking block 4013 is fixed to the base 4011 and the first locking block 4012 is slidably connected to the base 4011, the elastic member 4014 being configured to apply a preload that drives the first locking block 4012 to slide toward the second locking block 4013, with the first locking block 4012 forming the locking portion.

Optionally, when no external force is applied, the first locking block 4012 and the second locking block 4013 contact each other along the first path, or are spaced apart along the first path by a distance smaller than the dimension of the hook 402 in the same direction.

In some embodiments, referring to FIGS. 1 and 6, the linear lighting apparatus further includes a fixing assembly 5. The fixing assembly 5 includes a fixing frame 501 and an elastic latch 502. The fixing frame 501 is connected to the lamp cover 1 and defines a fixing hole. The elastic latch 502 is disposed within the accommodation cavity 201 and connected to the lamp body 2. The elastic latch 502 includes a latching portion configured to engage with the fixing hole.

When the lamp body 2 and the lamp cover 1 are closed, the latching portion of the elastic latch 502 engages the fixing hole. When the lamp body 2 and the lamp cover 1 are separated, the latching portion disengages from the fixing hole. The fixing assembly 5 cooperates with the locking assembly 4 to further enhance the firmness and reliability of the connection between the lamp body 2 and the lamp cover 1.

In some embodiments, referring to FIG. 6, the elastic latch 502 includes an elastic base 5021 and an elastic sheet 5022. The elastic base 5021 includes a mounting plate connected to the lamp body 2 and a latching plate angled relative to the mounting plate. The elastic sheet 5022 is attached to the latching plate and forms the latching portion. The elastic sheet 5022 includes two latching zones arranged at an angle, one connected to the latching plate, and the joint between the two latching zones is inserted into the fixing hole.

The joint between the two latching zones forms an angle, and when inserted into the fixing hole, it locks the lamp body 2 and the lamp cover 1 together. To open the lamp cover 1, an external force is applied to the lamp cover 1, causing elastic deformation of the latching zones, thereby releasing them from the fixing hole.

Optionally, one latching zone is connected to the latching plate, and the other is a free end, facilitating elastic deformation and allowing easy engagement and disengagement of the latching portion with the fixing hole.

In some embodiments, referring to FIG. 1, the driver assembly 3 includes a driver 301 and a dial switch 302. The driver 301 is disposed within the accommodation cavity 201 and fixed to the lamp body 2, and is electrically connected to the light source unit 7. The dial switch 302 is electrically connected to the driver 301 and fixed to the lamp body 2, with its switch extending outside the accommodation cavity 201.

Because the switch of the dial switch 302 extends outward from the accommodation cavity 201, users can control the driver 301 through the dial switch 302 to adjust parameters of the light source unit 7, such as color or color temperature. In this embodiment, both the dial switch 302 and the driver 301 are disposed in the accommodation cavity 201, ensuring a compact internal layout and convenient operation.

In some embodiments, referring to FIGS. 1-3, the linear lighting apparatus further includes a hinge assembly 6. The hinge assembly 6 includes a first mounting portion 601, a hinge portion 603, and a second mounting portion 602 connected in sequence. The hinge portion 603 is a flexible member capable of elastic deformation. The first mounting portion 601 and the second mounting portion 602 are rotatably connected by the hinge portion 603. The first mounting portion 601 has a closed position parallel or contacting the second mounting portion 602, and an open position forming an angle or lying in the same plane. The first and/or second mounting portions rotate about the hinge portion 603 to switch between the open and closed positions.

The first mounting portion 601 and the second mounting portion 602 are respectively connected to the lamp body 2 and the lamp cover 1. During installation, the first and second mounting portions are in the open position. Because they are connected via the hinge portion 603, the installer does not need to hold the lamp cover 1. After the lamp body 2 is fixed, the first mounting portion 601 is rotated about the hinge portion 603 to the closed position, securing the lamp cover 1 to the lamp body 2. Since the hinge portion 603 is a flexible member capable of elastic deformation, no metal shaft is required, simplifying structure and reducing weight. This configuration allows single-person installation without lifting the lamp cover 1, lowering labor costs. Moreover, since the first and second mounting portions attach respectively to the lamp body 2 and lamp cover 1, the design can be applied to different lamp models without modifying their main structures, reducing design and production costs.

In some embodiments, referring to FIGS. 4-5, the inner side of the hinge portion 603 includes an arcuate groove 6031, and the outer side includes an arcuate projection 6032, giving the hinge portion 603 a curved cross section.

When the first mounting portion 601 and the second mounting portion 602 move from the open position to the closed position, the hinge portion 603 deforms, with the outer side undergoing a larger deformation than the inner side. If the hinge portion 603 were flat, the outer side would be overstretched while the inner side would buckle, causing gaps and possible fracture. In this embodiment, the arcuate projection 6032 on the outer side increases the deformation path to prevent rupture, and the arcuate groove 6031 on the inner side prevents material stacking when closed.

It should be noted that during bending of the hinge portion 603, the inner side travels a shorter distance than the outer side, meaning less deformation. The smaller inner surface area and larger outer surface area ensure sufficient flexibility on the outer side while preventing protrusion on the inner side.

In some embodiments, referring to FIGS. 4-5, the first and/or second mounting portions 601, 602 include a limiting rib 604. In the closed state, the limiting rib 604 forms a clearance space between the first and second mounting portions.

When closed, the limiting rib 604 abuts one of the mounting portions to prevent collision during rotation and to avoid interference of locking members, thereby improving connection reliability.

Optionally, the limiting rib 604 is made of a flexible material, such as rubber, plastic, or EVA, to prevent rigid contact. The limiting rib 604 may be integrally formed with or separately attached to either mounting portion.

In some embodiments, referring to FIGS. 2-3, the base 4011 defines a clearance hole penetrating therethrough. The coupling device includes a cover plate 4015 covering the clearance hole and a driving block 4016 connected to the cover plate 4015. The driving block 4016 slides within the clearance hole to form the driving portion.

By moving the cover plate 4015 along the first path, the driving block 4016 slides within the clearance hole, compressing the elastic member 4014 and releasing the hook 402. The cover plate 4015 seals the clearance hole to enhance the internal sealing of the lamp body 2 and lamp cover 1, preventing moisture or dust ingress and extending service life.

Optionally, when both the first and second locking blocks 4012, 4013 are slidably connected to the base 4011, two elastic members 4014 apply force respectively, and two cover plates 4015 and corresponding driving blocks 4016 are provided. By moving the two cover plates 4015 in opposite directions, the first and second locking blocks 4012, 4013 move apart.

Optionally, the first or second locking block 4012, 4013 is connected to the cover plate 4015. Specifically, the lamp body 2 defines a relief hole communicating with the accommodation cavity 201, and the driving block 4016 slides within the relief hole.

In some embodiments, referring to FIG. 4, the light-transmitting cover 101 includes a cover body 1011, a fixing flange 1012 at the edge of the cover body 1011, and a latching strip 1013 connected to the cover body 1011. The fixing flange 1012 and the latching strip 1013 are spaced apart to form a mounting groove, into which the heat-dissipating plate 102 is inserted.

This plug-in connection between the heat-dissipating plate 102 and the light-transmitting cover 101 avoids the need for openings in either component, improving sealing within the mounting chamber 103 and preserving the integrity of the light-transmitting cover 101.

In some embodiments, referring to FIG. 4, the latching strip 1013 includes a connecting portion and a limiting portion arranged at an angle. The connecting portion connects to the cover body 1011, and the limiting portion bends toward the mounting groove. The heat-dissipating plate 102 includes a main plate 1021 and a latching flange 1022 extending from its edge. The latching flange 1022 is inserted into the mounting groove and engages the limiting portion.

By engaging the latching flange 1022 with the limiting portion, the components are secured without tight interference, reducing insertion resistance while ensuring stable fixation through mechanical engagement.

The lighting apparatus disclosed herein is designed to provide a safe, efficient, and adaptable lighting structure suitable for ceiling or wall installation. It includes a lamp body, a lamp cover, and a hinge structure formed as an extruded polymer member. The hinge structure connects the lamp body and the lamp cover in a manner that allows the lamp cover to rotate relative to the lamp body. This configuration facilitates easier wiring, configuration, and maintenance of the lamp, while also improving sealing performance once the lamp cover is closed. In practical applications, the lamp body can be made of aluminum, steel, or other thermally conductive materials to ensure sufficient heat dissipation, while the lamp cover may be transparent, translucent, or semi-transparent to achieve desired light diffusion effects.

The hinge structure, which serves as the main mechanical connection between the lamp body and the lamp cover, is formed as an extruded polymer member. This term encompasses structures made of thermoplastic or thermoset polymers, such as polycarbonate (PC), polyvinyl chloride (PVC), polyethylene terephthalate (PET), or thermoplastic elastomers (TPE). In certain embodiments, the extruded polymer member may include a co-extruded reinforcement layer made of fiber-reinforced polymer or an embedded metallic wire for enhanced mechanical strength. The use of extrusion allows for continuous production of the hinge with uniform geometry and provides excellent flexibility for repeated opening and closing without fatigue cracking.

The hinge structure comprises three main parts: a first fixing portion, a second fixing portion, and a connecting section. The first fixing portion is securely attached to the lamp body, which may be accomplished through fasteners, adhesives, ultrasonic welding, or an interlocking groove. The second fixing portion is connected to the first cover side of the lamp cover, which can be implemented via screw fastening, snap-fitting, or heat staking. The connecting section between the two fixing portions acts as a flexible joint, which may take the form of a thin polymer bridge, a flexible spine, or a multi-layer segment combining rigidity and elasticity. This connecting section allows the lamp cover to pivot smoothly relative to the lamp body during installation or maintenance.

When the lamp body is mounted in an installation position, such as on a ceiling surface or a wall bracket, the hinge structure allows the lamp cover to hang naturally downward. In this position, the user can easily access the interior components of the lamp body, such as the driver or wiring terminals, without supporting the entire lamp cover manually. This design minimizes the risk of injury and damage during installation, particularly for ceiling-mounted fixtures. Once installation and configuration are completed, the user rotates the lamp cover upward along the hinge structure to close it, ensuring that the cover and body fit tightly to form a sealed assembly.

The coupling structure mentioned in the dependent claims provides an additional securing function once the lamp cover is rotated to the closed position. This coupling structure may include an elastic member, such as a spring, a leaf plate, or a compressible polymer component, and a movable member such as a latch or sliding hook. When the user operates the movable member, the elastic member deforms temporarily, allowing the hook or latch to engage with a corresponding recess or groove on the lamp body. Once the user releases the movable member, the elastic member returns to its original shape, locking the lamp cover securely in place. This self-locking mechanism reduces the need for external fasteners and simplifies field assembly.

In alternative embodiments, the coupling structure may adopt various locking geometries. For example, the movable member may include a cam-type mechanism, a push-button latch, or a magnetic catch that can maintain the lamp cover's closed position through magnetic attraction rather than mechanical engagement. The elastic member may also be implemented using elastomeric pads or shape-memory alloy elements that respond to temperature changes. These variations provide flexibility in adapting the invention to different design preferences and manufacturing constraints, while still performing the same essential function of securing the lamp cover to the lamp body.

The hinge structure can also integrate electrical functions. In some embodiments, a conductive channel is embedded within or alongside the extruded polymer member. This conductive channel can be implemented using copper strips, printed flexible circuits, or conductive polymer composites. Through this channel, power and control signals are transferred from the lamp body to the light source located on the lamp cover. Such an integrated design eliminates the need for separate wiring harnesses between the lamp body and lamp cover, simplifying assembly and improving long-term reliability by reducing wire fatigue or breakage during rotation.

To ensure stable and durable attachment, the hinge's first and second fixing portions may employ multiple fasteners or mechanical interlocks arranged in an alternating pattern. The fasteners can be screws, rivets, or snap-fit pegs, depending on the material and desired rigidity. In some designs, adhesive bonding or laser welding may be used to achieve water-resistant joints. The alternating arrangement of fastening points ensures even load distribution along the hinge and prevents local stress concentration, thereby extending the service life of the lamp's rotational connection.

The lamp body houses key electrical and optical components. It typically includes a driver module, a configuration switch, and an optional control interface. The driver converts input AC voltage to a regulated DC voltage suitable for powering LED modules. The configuration switch, which can be a mechanical dial, push-button, or software-controlled interface, allows users or installers to set lighting parameters such as brightness, correlated color temperature, or dimming curve. In advanced embodiments, the configuration switch may support digital communication protocols such as DALI, 0-10 V, or DMX, enabling network-based control of multiple luminaires.

The light source mounted on the lamp cover may consist of one or multiple LED modules. Each LED module can have different color temperatures or chromaticity characteristics. By selectively adjusting the drive current or modulation duty cycle of each module, the lamp achieves tunable white or color-changing illumination. To enhance optical performance, the lamp cover may integrate secondary optics such as linear lenses, diffusers, or reflective films. These optical elements can be molded directly into the light-transmitting cover or attached as separate components. The combination of optical and mechanical design ensures that the emitted light is evenly distributed and that the luminaire maintains a sleek, low-profile appearance.

In certain implementations, the light-transmitting cover of the lamp cover may be made of polycarbonate, acrylic (PMMA), or tempered glass, depending on the application environment. Polycarbonate materials offer superior impact resistance and are suitable for industrial or warehouse installations, while acrylic provides higher optical clarity for architectural or decorative lighting. In some versions, a surface coating or micro-textured pattern may be applied to the inner face of the cover to reduce glare or produce a softer lighting effect. The heat-dissipating plate, meanwhile, may be formed of extruded aluminum, die-cast aluminum alloy, or graphite-composite materials to provide efficient thermal conduction and maintain optimal LED operating temperature.

The sealing between the lamp body and the lamp cover is achieved through design features such as gaskets, waterproof strips, or molded lips. A waterproof strip may be made of silicone rubber, EPDM, or thermoplastic elastomer, compressed when the cover closes to form a watertight seal. Depending on installation requirements, the overall structure can achieve ingress protection ratings such as IP65 or IP67. Such sealing structures are critical for outdoor or bathroom applications where humidity and dust may compromise the longevity of internal electronic components. The sealing also protects the optical components from yellowing or contamination over time.

The driver assembly within the lamp body can be modular, allowing easy replacement or upgrade. In one embodiment, the driver assembly is fixed inside the accommodation cavity using screws or sliding rails and electrically connected to the LED modules through plug-type connectors. In another embodiment, the driver is potted in silicone gel for improved heat dissipation and moisture protection. The driver may include power factor correction, surge protection, and dimming circuitry. A dial switch, toggle switch, or DIP switch can extend from the accommodation cavity for quick configuration by installers. By simply opening the lamp cover, installers can set color temperature, brightness level, or operating mode without removing the entire lamp.

The locking assembly positioned in the accommodation cavity provides a convenient means to fix and release the lamp cover. The coupling member of the locking assembly may include two or more locking blocks, which engage or disengage corresponding hooks or grooves of the lamp cover. The locking mechanism may rely on mechanical force, elastic preload, or a combination thereof. In advanced versions, a user-accessible driving block can be operated manually or by tool insertion to release the lock. This design minimizes disassembly time and improves serviceability during maintenance or LED replacement.

For further reinforcement, an additional fixing assembly can be employed. This assembly typically includes a fixing frame and an elastic latch that interlock when the lamp cover is closed. The latch may be shaped as a spring tongue, resilient hook, or bayonet-type fastener. When the lamp cover is pressed into position, the elastic latch automatically snaps into the fixing hole of the frame. To open the cover, the installer applies gentle pressure or inserts a tool to deform the latch, releasing the connection. This mechanism ensures that even under vibration or minor impact, the lamp cover remains securely attached to the lamp body.

In some embodiments, the lighting apparatus includes a hinge assembly that integrates both structural and functional flexibility. The hinge assembly may consist of a first mounting portion attached to the lamp body, a second mounting portion attached to the lamp cover, and a flexible hinge portion in between. The hinge portion can be formed from an elastic polymer, silicone rubber, or woven composite with elastomer coating. Such materials provide repeated bendability without permanent deformation. When the lamp is open for wiring or inspection, the hinge portion supports the cover's weight, eliminating the need for a second person to hold it. When the cover is closed, the hinge portion returns to its original shape, ensuring consistent alignment and sealing.

To further enhance durability, the hinge portion may have a curved or ribbed cross section. A concave inner surface and convex outer surface allow balanced deformation, reducing tensile stress on the outer bend and compressive buckling on the inner bend. This geometric optimization prevents cracking or material fatigue after long-term use. The hinge portion can also integrate a small metal or fiber reinforcement strip embedded during extrusion to prevent rupture in case of fire or extreme temperature conditions. This dual-material structure ensures mechanical integrity even if the polymer softens or melts.

In another variant, the hinge structure may include decorative or functional illumination features. A small LED strip or optical fiber may be embedded inside the hinge or positioned adjacent to its translucent section, creating a side-light effect or accent lighting. This light-transmissive hinge design can serve as a visual indicator, for example, signaling power status or providing ambient lighting along architectural lines. The driver within the lamp body may include a dedicated output channel for controlling this secondary side-light function, either continuously or as a dimmable option.

The design allows flexibility in manufacturing methods. While extrusion is a preferred method for forming the hinge, other molding techniques such as injection molding, blow molding, or overmolding can also be used. For example, a two-shot molding process may form both rigid fixing portions and a flexible connecting section from different polymer materials in a single operation. Alternatively, the hinge could be co-extruded with embedded conductive or reinforcement layers, depending on the performance requirements. Such manufacturing flexibility enables adaptation to different product lines or cost targets.

From an assembly standpoint, the entire lighting apparatus is designed for ease of installation and maintenance. During assembly, the hinge structure is first secured to the lamp body. The lamp cover, with pre-installed LED modules and optical elements, is then attached to the hinge's second fixing portion. Once assembled, the installer can mount the lamp body to the ceiling or wall using screws, clamps, or magnetic brackets. After wiring and electrical testing, the lamp cover is simply rotated upward to close and lock in position through the coupling and fixing structures. The modular architecture allows fast production, efficient installation, and safe operation even in elevated environments.

In another embodiment, the lamp body may include a housing with internal compartments configured to accommodate a driver box, wiring terminals, and optional sensors. The housing may be extruded aluminum for linear luminaires or die-cast alloy for compact fixtures. It can include a through-hole or wire entry for connecting to an external power cable, which may be sealed using a gland or grommet to prevent water ingress. The housing can further include cooling fins or slots to enhance natural convection airflow, thereby maintaining optimal thermal performance. In addition, surface treatment such as anodizing or powder coating may be applied to improve corrosion resistance and surface appearance.

The light source of the lighting apparatus may take various forms depending on the intended lighting effect. It can use a continuous LED strip, modular LED boards, or COB (chip-on-board) light engines. In certain configurations, the light source may include LEDs of different color temperatures or colors, which are selectively driven to produce dynamic color mixing or tunable white light. The optical system can incorporate lenses, diffusers, or linear prisms to control beam shape and distribution. This flexibility allows the lighting apparatus to serve in diverse applications, such as architectural accent lighting, corridor illumination, retail display lighting, or general ambient lighting.

To improve safety, the driver assembly may include built-in protection circuits, such as overvoltage, overcurrent, short-circuit, and thermal protection. A safety interlock can also be integrated so that when the lamp cover is open, the electrical connection to the LED modules is automatically cut off. This ensures that installers or maintenance personnel do not encounter live electrical parts. For smart versions of the product, the driver may include wireless communication modules, such as Bluetooth Mesh, Zigbee, or Wi-Fi, enabling remote control, group dimming, or integration into building management systems.

The lamp cover can be enhanced with optical and mechanical accessories. For instance, an anti-glare baffle, micro-louver, or frosted diffuser can be fitted to the inner surface to optimize light distribution. The heat-dissipating plate may include a reflective coating or an integrated optical reflector to improve luminous efficiency. In some versions, the cover may be hinged at one side and latched at the other, or in other versions, both sides can include hinges for symmetric installation. The cover may also be replaceable, allowing different designs or finishes to be used for aesthetic or functional customization.

To facilitate manufacturing and field maintenance, many structural components of the lighting apparatus can be modular. The hinge structure, coupling structure, and locking assembly can each be prefabricated and assembled in sequence. Fasteners, if used, may be standardized to reduce tooling complexity. In some versions, snap-fit or slide-in joints eliminate the need for screws entirely, allowing tool-free assembly and disassembly. This modularity also allows the same lamp body design to support different cover types, optical modules, and mounting accessories, simplifying inventory management and reducing production cost.

The invention also contemplates variations in installation orientation. While the exemplary embodiments describe ceiling-mounted configurations, the same hinge and locking design can be applied to wall-mounted or pendant luminaires. When used in wall applications, the hinge allows the cover to swing sideways rather than downward. When used as a pendant light, the hinge can act as both a mechanical and electrical connection between the suspension module and the illumination body. These variations demonstrate the structural adaptability and broad applicability of the disclosed concept.

Environmental considerations are also addressed in the design. The extruded polymer member used in the hinge structure may be recyclable or made from low-VOC, halogen-free materials. The lamp body and heat-dissipating components can use recycled aluminum alloys to reduce carbon footprint. The modular design further supports circular economy principles, allowing individual parts such as LED boards or drivers to be replaced without discarding the entire fixture. This sustainability aspect aligns with modern energy and environmental regulations in global markets.

In operation, the lamp functions as follows. The installer first secures the lamp body to the mounting surface and connects the power cables through the provided openings. With the hinge allowing the cover to hang safely, the installer configures the driver or switch settings as needed. After verifying electrical connections, the installer rotates the lamp cover upward, where the coupling and locking assemblies automatically engage, ensuring a secure and sealed connection. To perform maintenance, the user simply releases the locking assembly through the driving block or latch mechanism and lowers the cover. This straightforward procedure minimizes installation time and enhances safety.

From a mechanical standpoint, the design ensures high reliability under repeated operation. The hinge undergoes thousands of open-close cycles without mechanical fatigue. The locking and coupling structures are tested for vibration and impact resistance to meet industrial lighting standards. The waterproofing system maintains its elasticity and sealing capability after prolonged exposure to temperature variation and UV radiation. Overall, the invention achieves a balanced combination of structural simplicity, mechanical robustness, and functional versatility.

In summary, the disclosed lighting apparatus provides a comprehensive solution for safe, efficient, and flexible installation of ceiling or wall-mounted luminaires. Its extruded polymer hinge structure, integrated coupling and locking assemblies, and modular internal layout simplify assembly, improve safety during installation, and enable versatile configurations. By incorporating conductive channels, sealing features, and optional smart control functions, the invention extends beyond a basic fixture to become a scalable platform adaptable to different applications. Those skilled in the art will appreciate that various modifications, substitutions, and equivalents may be employed without departing from the spirit and scope of the invention, which is defined by the appended claims.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus, comprising:
a lamp body;
a hinge structure, wherein the hinge structure is an extruded polymer member connecting the lamp body and a lamp cover; and
the lamp cover, wherein the hinge structure comprises a first fixing portion, a second fixing portion, and a connecting section, wherein the first fixing portion is fixedly connected to the lamp body, wherein the second fixing portion is fixedly connected to a first cover side of the lamp cover, wherein the lamp cover is rotatable relative to the lamp body along the hinge structure, and wherein, when the lamp body is mounted at an installation position, the lamp cover hangs downward for user access to perform configuration and installation of the lamp body, and after installation is completed, the lamp cover is rotated along the hinge structure to engage and close with the lamp body.

2. The lighting apparatus of claim 1, wherein the lamp cover further includes a coupling structure disposed at a second cover side of the lamp cover.

3. The lighting apparatus of claim 2, wherein the coupling structure comprises an elastic member and a movable member, wherein a user operates the movable member to engage the lamp cover with the lamp body and releases the movable member to complete fixation.

4. The lighting apparatus of claim 2, wherein the coupling structure comprises an elastic member and a slanted latch member, wherein a user operates the movable member to engage the lamp cover with the lamp body and releases the movable member to complete fixation.

5. The lighting apparatus of claim 2, wherein the lamp body includes a locking hole, and wherein the coupling structure comprises a locking hook configured to engage the locking hole for fixation.

6. The lighting apparatus of claim 2, wherein the second cover side of the lamp cover includes a waterproof strip configured to prevent moisture ingress into the lamp body when the lamp cover and the lamp body are fixed together.

7. The lighting apparatus of claim 1, wherein the lamp body includes a driver and a configuration switch, wherein, when the lamp cover is opened, a user operates the configuration switch to perform parameter setting of a driving circuit.

8. The lighting apparatus of claim 7, further comprising a light source including a plurality of LED modules having different optical parameters, wherein the configuration switch is operable to adjust a mixing ratio of the LED modules to obtain a desired color temperature.

9. The lighting apparatus of claim 8, wherein the configuration switch includes indicia corresponding to a plurality of discrete color-temperature settings.

10. The lighting apparatus of claim 1, wherein the hinge structure further includes a conductive channel, and wherein the lamp cover includes a light source electrically connected to a power supply of the lamp body through the conductive channel.

11. The lighting apparatus of claim 1, wherein the first fixing portion includes a plurality of first fasteners, and the second fixing portion includes a plurality of second fasteners, and wherein the plurality of first fasteners and the plurality of second fasteners are alternately arranged.

12. The lighting apparatus of claim 1, wherein the second fixing portion of the hinge structure and the lamp cover are fixed through a sliding-rail structure.

13. The lighting apparatus of claim 1, wherein the lamp body includes a housing defining an accommodation space in which a driver box is disposed, and wherein the housing includes a wire-passing hole through which an external power cable extends to the driver box.

14. The lighting apparatus of claim 1, wherein the lamp body includes an LED module having a protective layer.

15. The lighting apparatus of claim 1, wherein the extruded polymer member has different wall thicknesses along different segments thereof.

16. The lighting apparatus of claim 1, wherein the lamp body includes a strip-shaped light source.

17. The lighting apparatus of claim 16, wherein the lamp cover includes a lens structure corresponding to the strip-shaped light source.

18. The lighting apparatus of claim 1, wherein the hinge structure further includes a metal strip embedded therein, wherein, when the extruded polymer member melts under fire conditions, the metal strip maintains mechanical connection between the lamp body and the lamp cover.

19. The lighting apparatus of claim 1, wherein the hinge structure is light-transmissive and includes a light source configured to emit light through the hinge structure to generate a side-light effect.

20. The lighting apparatus of claim 19, wherein the lamp body includes a driver operable to selectively activate the side-light effect.
